(19) United States
(12) Patent Application Publication
(10) Pub. No.: US 2016/0101820 A1
(43) Pub. Date: Apr. 14, 2016

(54) BICYCLE SEAT AND COVER

(71) Applicants: Griffin Sinn, Bloomington, IN (US); Kristian Gebhardt, Indianapolis, IN (US)

(72) Inventors: Griffin Sinn, Bloomington, IN (US); Kristian Gebhardt, Indianapolis, IN (US)

(21) Appl. No.: 14/880,804

(22) Filed: Oct. 12, 2015

Related U.S. Application Data
(60) Provisional application No. 62/062,360, filed on Oct. 10, 2014.
(60) Provisional application No. 62/140,568, filed on Mar. 31, 2015.

(51) Int. Cl. B62J 1/20

(52) U.S. Cl. CPC B62J 1/20

(57) ABSTRACT

Several different covers for a bicycle seat which can be stowed within the underside on the seat when not in use. Optionally, the seat covers are removable or detachable and may include auxiliary storage for other articles.

### CROSS REFERENCE TO RELATED APPLICATIONS

This application is related to and claims priority to U.S. Provisional Patent Application No. 62/062,360 filed on Oct. 10, 2014 and to U.S. Provisional Patent Application No. 62/140,568 filed on Mar. 31, 2015, both of which are incorporated herein by reference.

### BACKGROUND

Cycling has grown into a popular mode of transportation for both casual and competitive riders. Currently cyclists struggle keeping their bike seats dry during inclement weather when parking bicycles outside. Some cyclists resort to using disposable plastic bags to cover their seats between rides, but this solution requires the rider to remember to bring a bag with when the weather may be wet. This solution also requires the rider to have access to plastic bags which are falling out of favor in many locations and which can be fragile and tear easily thereby making them ineffective at protecting the seat from moisture.

Seat covers can be used to keep the seat dry, but then the rider is left with the problem of storing a wet cover after removing it from the seat. Additionally, an attached seat cover may be subject to theft if visibly left attached to the seat when not in use. Another issue are potentially damaging environmental effects to bicycle seats from conditions such as ultraviolet light, rain, snow, sleet, bird droppings, road debris (such as when transporting a bicycle on a vehicle rack), and the like. What is needed is a bicycle seat cover which can be deployed to protect a seat when needed and stowed and/or removed when not in use.

### BRIEF DESCRIPTION OF THE DRAWINGS

FIG. 1 is a top plan view of a seat cover according to one example of the disclosed invention.

FIG. 2 is a bottom plan view of the seat cover of FIG. 1.

FIG. 3 is a partial cut away side view of the seat cover of FIG. 1.

FIG. 4 is a bottom plan view of a seat cover according to another example of the disclosed invention.

FIG. 5 is a top plan view of a seat cover according to still another example of the disclosed invention.

FIG. 6 is a partial cut away side view of a seat cover according to another example of the disclosed invention.

FIG. 7 is a side view of a seat cover according to yet another example of the disclosed invention.

FIG. 8 is a rear view of a seat cover according to still another example of the disclosed invention.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

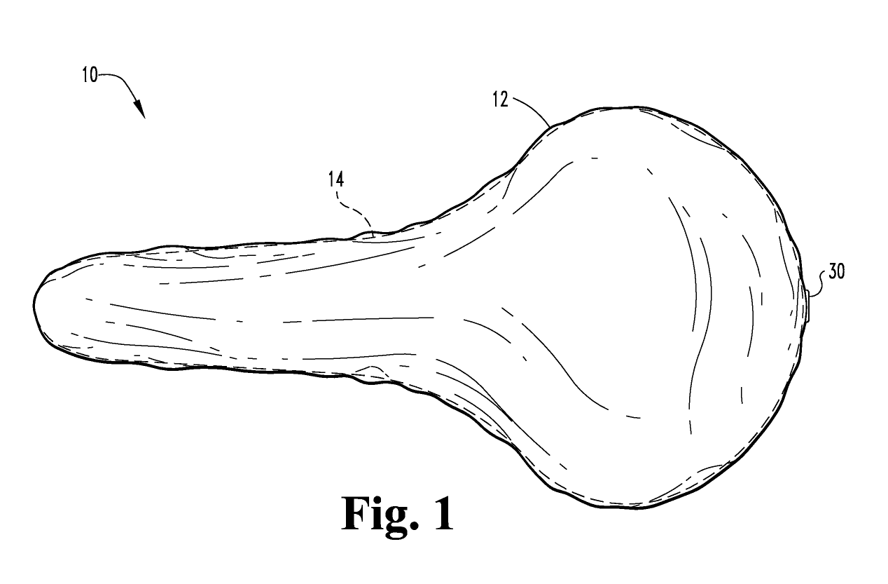

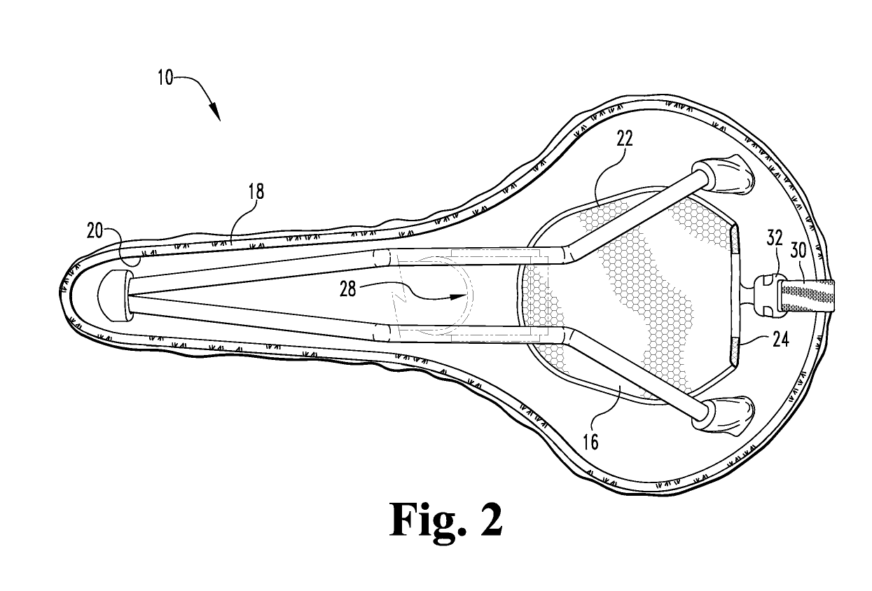

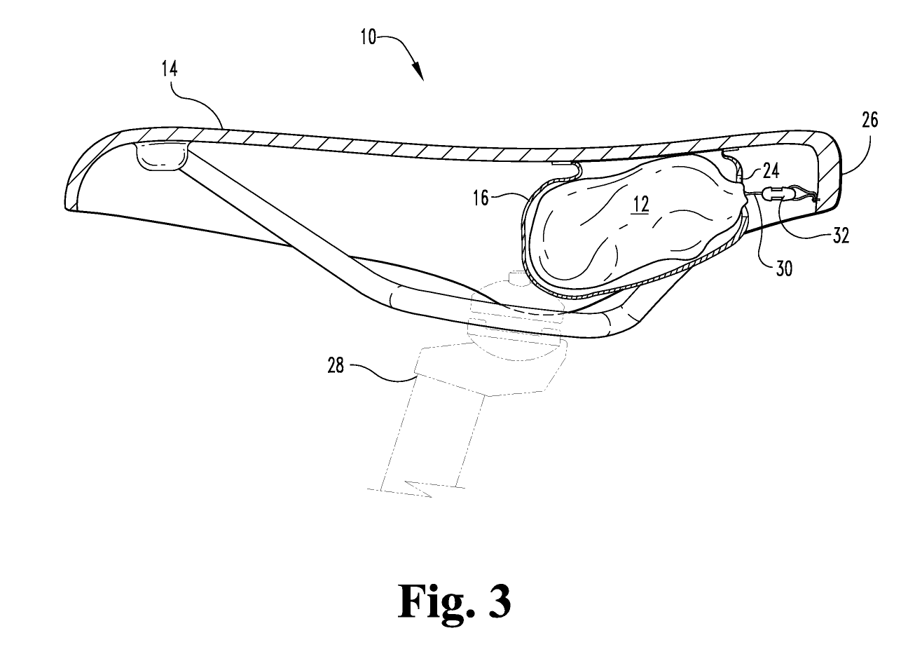

A first example of the disclosed invention comprises a cover 10 sized and adapted to cover a saddle-type bicycle 14 seat as shown in FIGS. 1-3. In this particular example, a bicycle saddle 14 is equipped with a seat cover 10 according to one embodiment of the disclosed invention. The seat cover 10 includes a cover body portion 12 sized and configured so as to cover the saddle 14 when deployed as shown in FIGS. 1-2 and a storage portion 16 as shown in FIG. 3. In this particular example, the cover portion 12 includes an elastic band 18 fixed to the outer edge 20 of the cover portion 12 by a suitable means such as stitching or adhesive. The elastic band 18 allows the perimeter of the cover portion 12 to stretch while being drawn over the saddle 14 when being deployed then draws the outer edge 20 of the cover portion 12 inward to secure it around the saddle 14 when released. When the cover portion 12 is being moved to the stowed position (FIG. 3) the elastic band 18 may be stretched so as to allow the cover body portion 12 to be drawn over the body of the saddle 14. The cover portion 12 can then be folded and stowed within the storage portion 16.

In this example, the storage portion 16 is a pouch 22 comprising a nylon mesh having an elastic-lined open end 24. The open mesh of the pouch 22 allows the cover portion 12 to be exposed to air when in the stowed position, thereby allowing it to dry. An elastic lined opening 24 allows the cover portion 12 to be removed or placed within the mesh pouch 16 as desired while biasing the opening closed. The pouch 16 is secured to the underside of the saddle 14 using a suitable means such as rivets, staples, adhesive, stitching, clips, ties, and the like. In other embodiments, the storage portion is integrated into and/or is formed as part of the saddle. Typically the pouch 16 is disposed entirely under the saddle 14 and may or may not extend below the sides 26 of the saddle. In this example as shown in FIG. 3, the pouch 16 is entirely within the underside of the saddle 14 and generally not visible from the side. The pouch 16 is deployed under the saddle 14 aft of the bicycle seat post attachment point 28 in this example. In other examples, placement of the pouch can be adapted as desired to account for variations in saddle mounting configurations. The pouch positioning can also be adapted to account for other considerations such as seat suspension components and the like.

Continuing with the present example, the cover body portion 12 and the storage portion 16 as connected by a strap 30. The strap 30 in this particular example comprises two lengths of nylon webbing separably joined by a clip 32. The strap 30 prevents the cover portion 12 from being accidentally lost and the clip 32 allows the cover portion 12 to be removed such as for cleaning or replacement if it becomes damaged. In other examples the strap 30 may be made of plastic, rubber, leather, cloth, or other suitable material. The clip 32 may be made from suitable materials such as metal or plastic or it may be replaced with snaps, buttons, hooks, or other suitable joining means. In still other examples, the joining means is omitted and the cover body portion may be permanently or semi-permanently mounted to the saddle or to the pouch as desired.

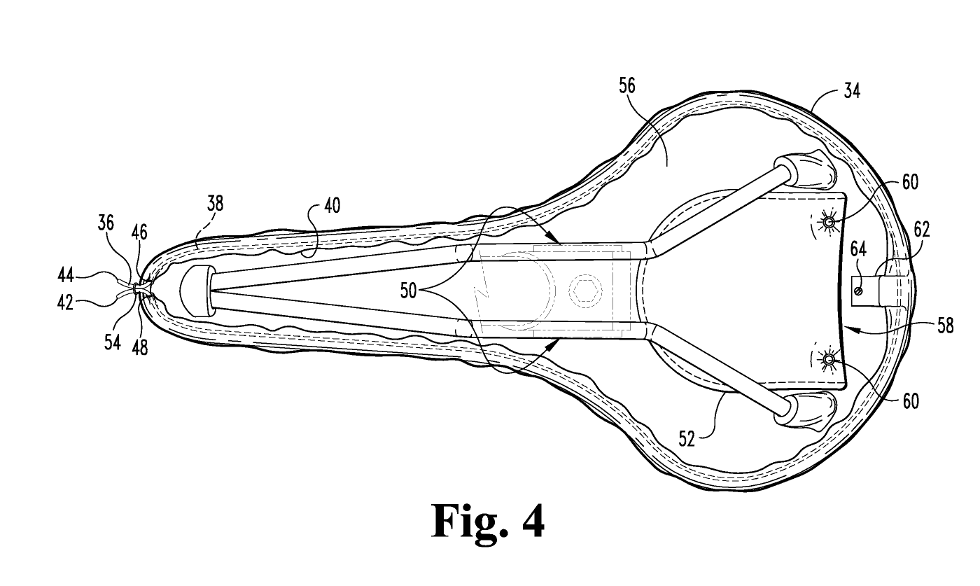

FIG. 4 shows another example of the disclosed invention. In this particular example, the cover portion 34 includes a cord 36 sewn into a channel 38 in the outer perimeter 40 of the cover portion 34. The perimeter may optionally be stretchable as in the previous example. The cord 36 may be made of cloth, leather, elastic, polymer, or the like. The ends 42, 44 of the cord 36 exit the channel at two openings 46, 48 fore of the saddle attachment point 50 distal from the storage pouch 52. Optionally, the openings 46, 48 are reinforced with metal or plastic grommets. The ends of the cord 42, 44 pass through a toggle 54 or cinch which allows the cord 36 to be drawn tight and releasable held so as to secure the cover portion 34 over the saddle 56 when deployed. The cinch 54 can then be released and the cover 34 removed when moving it to the stowed position.

The pouch storage portion 52 in this example is made of a solid fabric material so as to protect the cover portion 34 in the stowed position. The opening 58 in the pouch 52 is secured using snaps 60. The cover portion 34 is attached to a strap 62 which is secured to the underside of the saddle 56 using a screw 64 or other suitable fastener. Securing the cover portion 34 to the saddle 56 without an easily released toggle or latch such as in the previous example prevents theft of the cover without cutting or otherwise damaging the device.

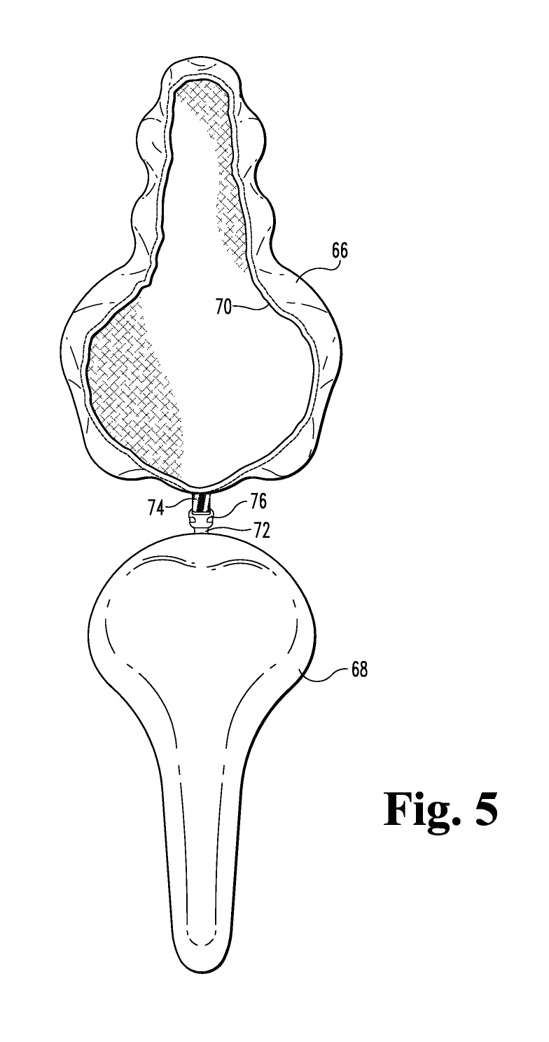

The example shown in FIG. 5 shows a seat cover 66 that is partially deployed. It has been removed from the storage portion (not shown) disposed below the saddle 68 but has not yet been placed over the saddle 68. This particular example includes a cover portion 66 which does not have any means of securing or tightening the edge 70 of the cover 66 such as elastic (FIGS. 1-3) or a cord (FIG. 4). The cover 66 is simply generally shaped and sized similar to the saddle 68 and allowed to drape over the saddle 68 in the deployed position. The cover portion 66 is secured to the saddle 68 using a pair of straps 72, 74 joined using an adjustable toggle 76 so as to allow the length of the strap to be adjusted as desired.

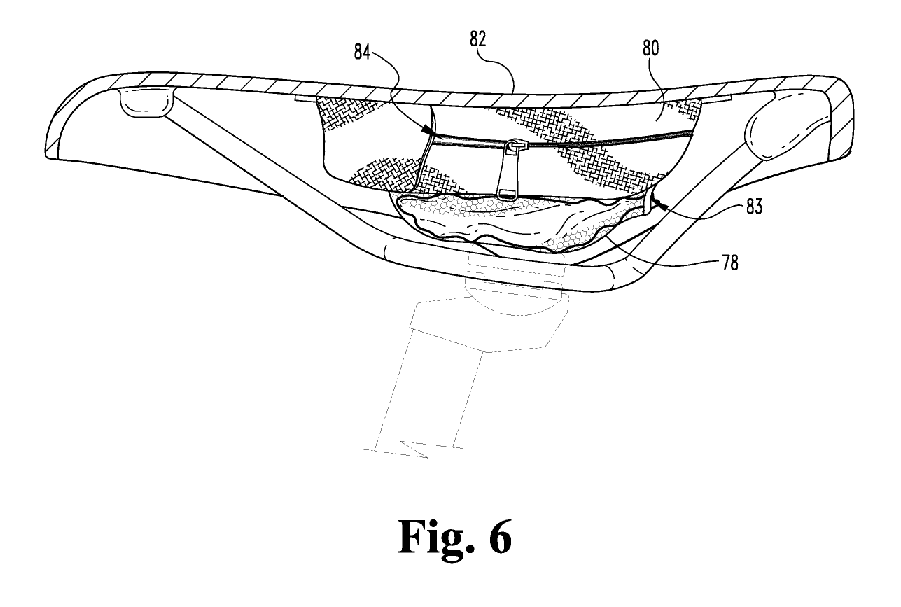

FIG. 6 shows a partial cut away view of another example of the disclosed invention. In this example, the cover storage portion 78 is attached to an auxiliary storage pouch 80 which is secured to the underside of the saddle 82. The cover storage pouch 78 and the auxiliary storage pouch 80 have separate openings 82, 84 which may be secured using elastic, snaps, zippers, or hook-and-eye style fabric, or other suitable closure means. In other examples, the cover storage pouch 78 and the auxiliary storage pouch 80 share a single opening. The auxiliary pouch 80 is sized so as to allow storage of items such as money, keys, small tools and bicycle parts, and the like. The cover storage pouch 78 is positioned below the auxiliary storage pouch 80 so as to prevent a wet cover (not shown) from draining water into the auxiliary storage pouch 80 when in the stowed position. In other examples the auxiliary storage pouch and the cover storage pouch are in a more side-by-side configuration or the cover storage pouch may be disposed between the saddle and the auxiliary storage pouch. In any of these variations the cover portion would function in a manner similar to those examples previously described.

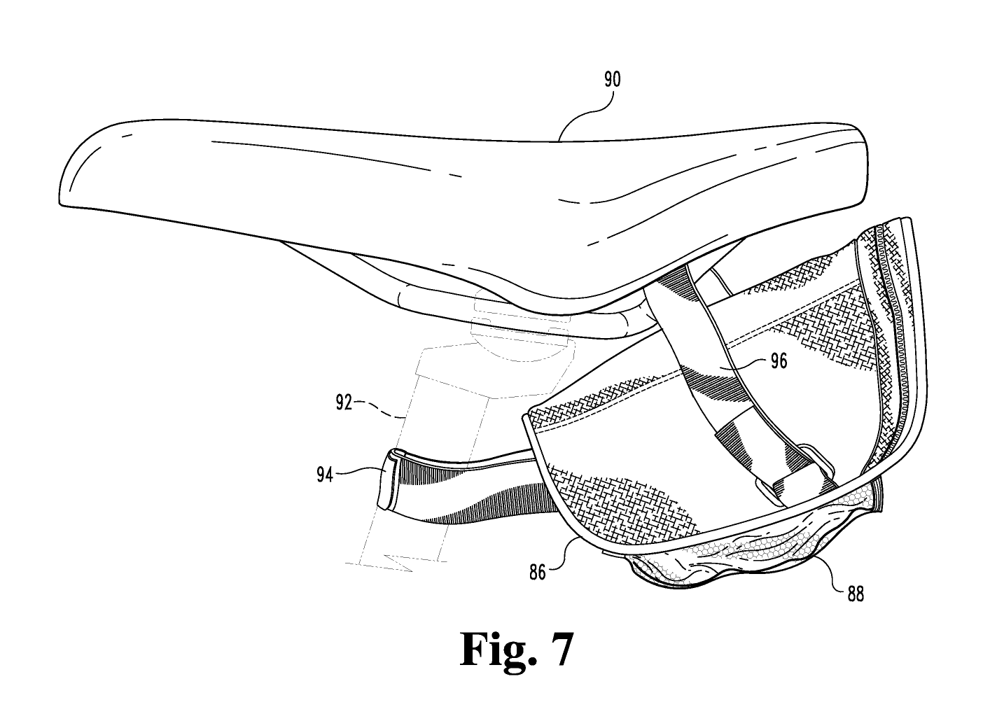

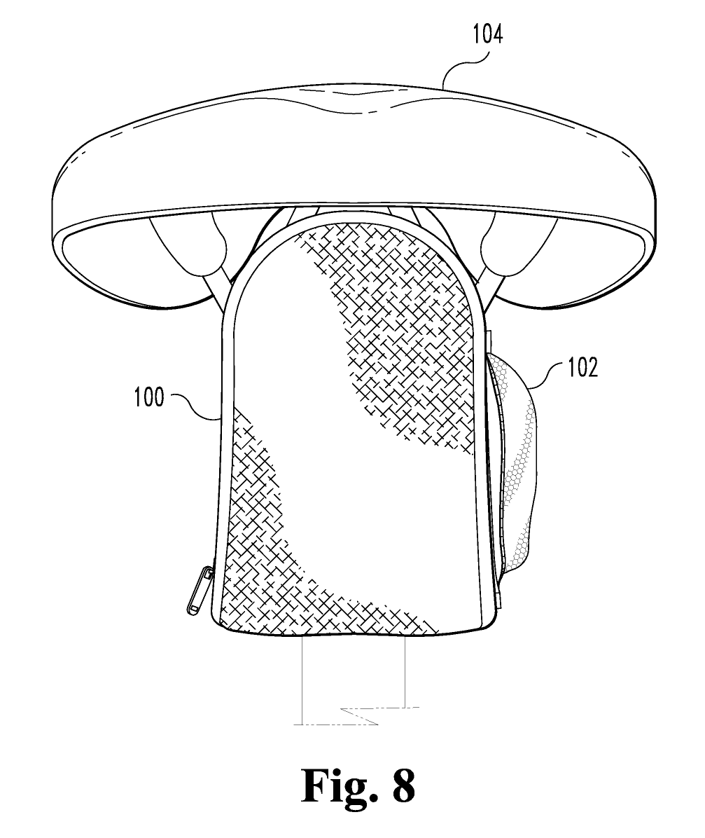

FIG. 7 shows an example of the disclosed invention having an auxiliary storage pouch 86 and a cover storage pouch 88 disposed below the saddle 90 but not within the saddle body as with the previous examples. The pouches may be secured to the saddle 90 similar to those examples previously described, such as by a strap 96. Optionally, the pouches in this example may also be secured to the saddle mounting bar 92 using a strap 94 or other suitable means. The cover portion would function in a manner similar to those examples previously described. The strap used to secure the cover portion to the cover storage pouch would need to be longer to account for the additional distance the cover portion is stored from the saddle. Optionally, the overall size of the cover could be increased so as to allow the cover portion to cover both the saddle and the auxiliary storage pouch, thereby shielding the auxiliary storage pouch from view when the cover is deployed. In other examples the auxiliary storage pouch 100 and the cover storage pouch 102 are disposed below the saddle seat 104 in a more side-by-side configuration such as is shown in FIG. 8 or the cover storage pouch may be disposed between the saddle and the auxiliary storage pouch. In any of these variations the cover portion would function in a manner similar to the example previously described where the auxiliary storage and cover storage pouch disposed below the saddle.

The seat covers, straps, and storage pouches in the preceding examples may be made from a variety of suitable materials, both synthetic and natural as well as combinations thereof. Various polymers such as nylon and vinyl, rubber, polytetrafluoroethylene membranes, carbon fibers, cotton, wool, hemp, and the like may be used. Composite and/or layered materials may also be used. In other examples, the cover portion may be made of more than one material, such as a waterproof vinyl outer shell to repel water and having a fleece inner shell to prevent scratching or other damage to an expensive saddle.

In the preceding examples of the disclosed invention, various covers are shown in combination with a traditional saddle-type bicycle seat. This particular type of seat is shown for illustrative purposes only. It is understood by one of ordinary skill in the art that the concepts of the disclosed invention could be adapted to fit different styles of bicycle seats including banana seats, ergonomic saddles, micro-saddles, racing saddles, saddles having suspension systems, seats having backs, and other styles of seats or saddles adapted for use on bicycles. It is also understood that the disclosed invention may be adapted for use with seats that are similar in size and configuration to bicycle seats such as scooter, motorcycle, moped, tractor, watercraft, buggy, swing, sled, and snowmobile seats. Covers according the disclosed invention may be generally narrower at one end than the other, generally oval in shape, or any other suitable irregular shape as desired to fit a particular bicycle seat shape and/or style. Typically a cover will be sized and configured so as to at least completely cover a particular bicycle seat on all exposed sides of the seat except for the underside of the seat. It is also understood that the seat or saddle may be made from a variety of materials including metal, plastic, wood, leather, and combinations thereof.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A cover for a bicycle seat, comprising:
a cover portion sized and configured to cover a bicycle seat and having a stretchable perimeter;
a storage portion removably mounted to the underside of the bicycle seat and having an opening through which the cover portion may pass; and
a connecting strap releasably joining the cover portion to the storage portion;
wherein the cover portion is held in place by the stretchable perimeter when covering the bicycle seat;
wherein the cover portion is foldable to fit within the storage portion.

2. The cover of claim 1, wherein the storage portion comprises a mesh material.

3. The cover of claim 1, wherein the stretchable perimeter further comprises a cord disposed in a channel following the perimeter such that the cover can be secured over the bicycle seat by cinching the cord.

4. The cover of claim 3, further comprising a toggle operably engaged to the cord.

5. The cover of claim 1, wherein the cover portion comprise a waterproof material.

6. The cover of claim 1, wherein the opening of the storage portion includes an elastic band biasing the opening closed.

7. The cover of claim 1, further comprising an auxiliary storage portion disposed between the storage portion and the seat.

8. The cover of claim 7, wherein the storage portion and the auxiliary storage portion are further secured to the bicycle seat mounting bar.

9. The cover of claim 1, wherein the seat includes sides which hide the storage portion from view.

10. A removable cover for a saddle-style seat, comprising:
a cover portion having a stretchable perimeter sized and configured to cover a seat;
a storage portion having an opening through which the cover portion may pass mounted to the underside of the seat; and
a connecting strap releasably joining the cover portion to the storage portion;
wherein the cover portion is held in place by the stretchable perimeter when covering the seat;
wherein the cover portion is hidden from view by the seat;
wherein the cover portion is foldable to fit within the storage portion.

11. The cover of claim 10, wherein the storage portion comprises a mesh material.

12. The cover of claim 10, wherein the stretchable perimeter further comprises a cord disposed in a channel following the perimeter such that the cover can be secured over the bicycle seat by cinching the cord.

13. The cover of claim 10, wherein the opening of the storage portion includes an elastic band biasing the opening closed.

14. The cover of claim 10, further comprising an auxiliary storage portion disposed between the storage portion and the seat.

15. A cover for a saddle-style seat, comprising:
a cover portion sized and configured to cover a seat and having a stretchable perimeter;
a storage portion mounted to the underside of the seat and having an opening through which the cover portion may pass; and
a connecting strap releasably joining the cover portion to the seat;
wherein the cover portion is held in place by the stretchable perimeter when covering the seat;
wherein the cover portion is foldable to fit within the storage portion.

16. The cover of claim 15, wherein the seat has sides which hide the storage portion from view.
